(19) United States
(12) Patent Application Publication
(10) Pub. No.: US 2020/0208804 A1
(43) Pub. Date: Jul. 2, 2020

(54) Luminaire With Uplight Features

(71) Applicant: Eaton Intelligent Power Limited, Dublin 4 (IE)

(72) Inventors: Westly Hetrick, Atlanta, GA (US); Michael Troy Winslett, Chattahoochee Hills, GA (US)

(21) Appl. No.: 16/725,826

(22) Filed: Dec. 23, 2019

Related U.S. Application Data
(60) Provisional application No. 62/785,503, filed on Dec. 27, 2018.

(51) Int. Cl. F21V 7/00; F21S 8/02; F21K 9/61

(52) U.S. Cl. CPC F21V 7/0016; F21Y 2115/15; F21K 9/61; F21S 8/026

(57) ABSTRACT

A luminaire includes a housing that houses a light transmission unit therein. The housing includes a back plate that has an uplight opening. The uplight opening is covered by a detachable panel that is removably coupled to the back plate. The light transmission unit includes a lightguide that receives light through the side edges and emits light through the major surfaces thereof. Further, the light transmission unit includes a reflector panel. In one example, the reflector panel is detachable to form an opening that allows light from the lightguide panel to pass through. In another example, the reflector panel includes patterned openings that allow light from the lightguide panel to pass through. The reflector panel is disposed in between one of the major surfaces of the lightguide panel and the back plate. The reflector segment and detachable panel comprise uplight features that are configured to provide uplight.

### RELATED APPLICATIONS

The present application claims priority to U.S. Provisional Patent Application No. 62/785,503 filed Dec. 27, 2018 and titled “Luminaire with Uplight Features.” The entire contents of the foregoing application are hereby incorporated herein by reference.

### TECHNICAL FIELD

Embodiments of the present disclosure relate generally to lighting systems, and more particularly to uplight features in luminaires for providing selective uplight.

### BACKGROUND

Luminaires, such as flat panel luminaires may be suspension mounted from ceilings using cables. When such suspension mounted luminaires are installed in an area, users may desire the luminaire to provide some amount of uplight, i.e., light directed towards the ceiling to prevent the creation of an undesirable “cave effect” in the area where the ceiling and space above the light fixtures are dark.

This background information is provided to reveal information believed to be of possible relevance to the present disclosure. No admission is necessarily intended, nor should be construed, that any of the preceding information constitutes prior art against the present disclosure.

### SUMMARY

In one aspect, the present disclosure relates to a luminaire that includes a housing assembly. The housing assembly includes a front frame, a back plate that is coupled to the front frame, and an internal cavity. The back plate includes an uplight opening that is formed therein. Further, the luminaire includes a detachable panel that is removably coupled to the back plate such that the detachable panel covers the uplight opening. Furthermore, the luminaire includes a light transmission unit disposed in the internal cavity of the housing assembly. The light transmission unit includes a lightguide panel that is configured to receive light from a light source through a side edge of the lightguide panel and emit the light through a pair of major surfaces of the lightguide panel that are substantially perpendicular to the side edge. The light transmission unit also includes a reflector panel. The reflector panel includes a detachable reflector segment formed therein. The reflector panel is disposed on a major surface of the pair of major surfaces of the lightguide panel and between the major surface and the back plate such that the detachable reflector segment is aligned with the uplight opening in the back plate. The detachable reflector segment and detachable panel include uplight features that are configured to be detached from the reflector panel and the back plate, respectively, to provide uplight.

In another aspect, the present disclosure relates to a luminaire that includes a back plate that has an uplight opening formed therein, and a detachable panel that is removably coupled to the back plate such that the detachable panel covers the uplight opening. Further, the luminaire includes a light transmission unit. The light transmission unit includes a lightguide panel that is configured to receive light from a light source through a side edge of the lightguide panel and emit the light through a pair of major surfaces of the lightguide panel that are substantially perpendicular to the side edge. Further, the light transmission unit includes a reflector panel that is disposed between one of the pair of major surfaces of the lightguide panel and the back plate. The reflector panel includes a reflector segment that is aligned with the uplight opening. The reflector segment and detachable panel comprise uplight features that are configured to provide uplight.

These and other aspects, features, and embodiments of the disclosure will become apparent to a person of ordinary skill in the art upon consideration of the following brief description of the figures and detailed description of illustrated embodiments.

### BRIEF DESCRIPTION OF THE FIGURES

The foregoing and other features and aspects of the present disclosure are best understood with reference to the following description of certain example embodiments, when read in conjunction with the accompanying drawings, wherein:

FIGS. 1A and 1B (collectively ‘FIG. 1’) illustrate top and bottom perspective views of an example luminaire with a first example uplight feature, in accordance with example embodiments of the present disclosure;

FIG. 2 illustrates an exploded view of the example luminaire of FIG. 1, in accordance with example embodiments of the present disclosure;

FIG. 3 illustrates a perspective view of a back plate of a housing of the luminaire of FIG. 1 with the detachable panels removed therefrom, in accordance with example embodiments of the present disclosure;

FIG. 4 illustrates a detachable panel of the back plate, in accordance with example embodiments of the present disclosure;

FIG. 5 illustrates a perspective view of a reflector of the luminaire of FIG. 1 with detachable reflector segments, in accordance with example embodiments of the present disclosure;

FIG. 6 illustrates an enlarged view of a portion of the reflector with the detachable reflector segments, in accordance with example embodiments of the present disclosure;

FIG. 7 illustrates a cross-sectional view of the example luminaire of FIG. 1, in accordance with example embodiments of the present disclosure;

FIG. 8 illustrates a perspective view of an example luminaire with a second example uplight feature with the detachable panels removed from the back plate of the luminaire, in accordance with example embodiments of the present disclosure;

FIG. 9 illustrates a perspective view of a reflector of the luminaire of FIG. 8 with graduated holes for uplight formed therein, in accordance with example embodiments of the present disclosure;

FIG. 10 illustrates a perspective view of an example luminaire with a third example uplight feature, in accordance with example embodiments of the present disclosure;

FIG. 11 illustrates a perspective view of a reflector of the luminaire of FIG. 10 with long triangular slots for uplight formed therein, in accordance with example embodiments of the present disclosure;

FIG. 12 illustrates an enlarged view of a portion of the reflector of FIG. 11, in accordance with example embodiments of the present disclosure;

FIG. 13 illustrates another enlarged view of a portion of the reflector of FIG. 11, in accordance with example embodiments of the present disclosure;

FIG. 14 illustrates a perspective view of an example luminaire with a fourth example uplight feature with louver panels, in accordance with example embodiments of the present disclosure;

FIG. 15 illustrates a perspective view of a reflector of the luminaire of FIG. 14, in accordance with example embodiments of the present disclosure;

FIG. 16 illustrates a perspective view of an example luminaire with a fifth example uplight feature, in accordance with example embodiments of the present disclosure;

FIGS. 17 and 18 illustrate perspective views of the back plate and the detachable panel of the example luminaire of FIG. 16, in accordance with example embodiments of the present disclosure;

FIG. 19 illustrates a perspective view of an example luminaire with a sixth example uplight feature, in accordance with example embodiments of the present disclosure;

FIG. 20 illustrates a perspective view of the reflector of the example luminaire of FIG. 19 with short triangular slots for uplight formed therein, in accordance with example embodiments of the present disclosure; and

FIG. 21 illustrates an enlarged view of a portion of the reflector of FIG. 20, in accordance with example embodiments of the present disclosure.

The drawings illustrate only example embodiments of the present disclosure and are therefore not to be considered limiting of its scope, as the present disclosure may admit to other equally effective embodiments. The elements and features shown in the drawings are not necessarily to scale, emphasis is instead placed upon clearly illustrating the principles of the example embodiments. Additionally, certain dimensions or positions may be exaggerated to help visually convey such principles.

### DETAILED DESCRIPTION OF EXAMPLE EMBODIMENTS

The present disclosure describes a luminaire that has uplight features configured to provide selective uplight. In one example, the uplight features may include detachable panels that are coupled to a back plate of a housing of the luminaire and detachable reflector segments formed in a reflector of the luminaire. The detachable panels of the housing and the detachable reflector segments of the reflector can be selectively removed by an end user to create the uplight. That is, by removing the detachable reflector segments of the reflector and the detachable panels that align with the detachable reflector segments from the back plate, the end user allows a portion of light exiting a lightguide panel through one of the major surfaces of the lightguide panel that faces the reflector and back plate to pass through the openings created by the removal of the detachable panels and the detachable reflector segments to provide an uplight.

In another example, instead of the detachable reflector segments, the uplight features may include patterns that are formed in the reflector to define openings in the reflector. For example, the patterns may include a plurality of graduated circular openings, or slots, or triangular openings, etc., that allow light to pass therethrough. That is, the patterns create multiple smaller openings as compared to a large opening that creates hard line boundaries when the detachable reflector segments are removed from the reflector panel. The multiple smaller openings may provide a smoother transition, mixing, and/or blending between a portion of the reflector panel having the uplight features and a remaining portion of the reflector panel. The smoother transition, mixing, and/or blending between the two portions of the reflector (i.e., the portion with uplight features and remaining portion) mitigates the appearance of large dark spots in the lightguide panel below the portions of the lightguide panel with the uplight features, e.g., when a user looks up at the luminaire (e.g., when the luminaire is lit). In yet another example, the uplight features may include louver panels or sliding panels coupled to the back plate. The sliding panels and/or louver panels may provide finer control over the amount of uplight emitted from the luminaire.

In the following paragraphs, luminaires with uplight features will be described in further detail by way of examples with reference to the attached drawings. In the description, well-known components, methods, and/or processing techniques are omitted or are briefly described so as not to obscure the disclosure. As used herein, the “present disclosure” refers to any one of the embodiments of the disclosure described herein and any equivalents. Furthermore, reference to various feature(s) of the “present disclosure” is not to suggest that all embodiments must include the referenced feature(s).

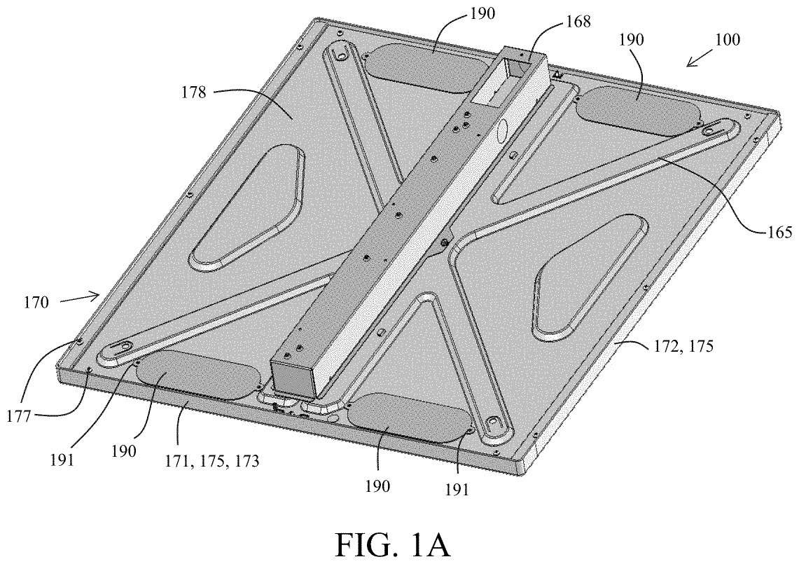

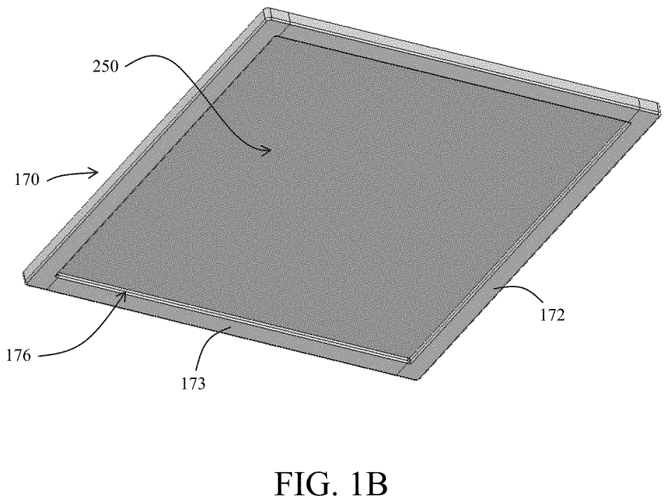

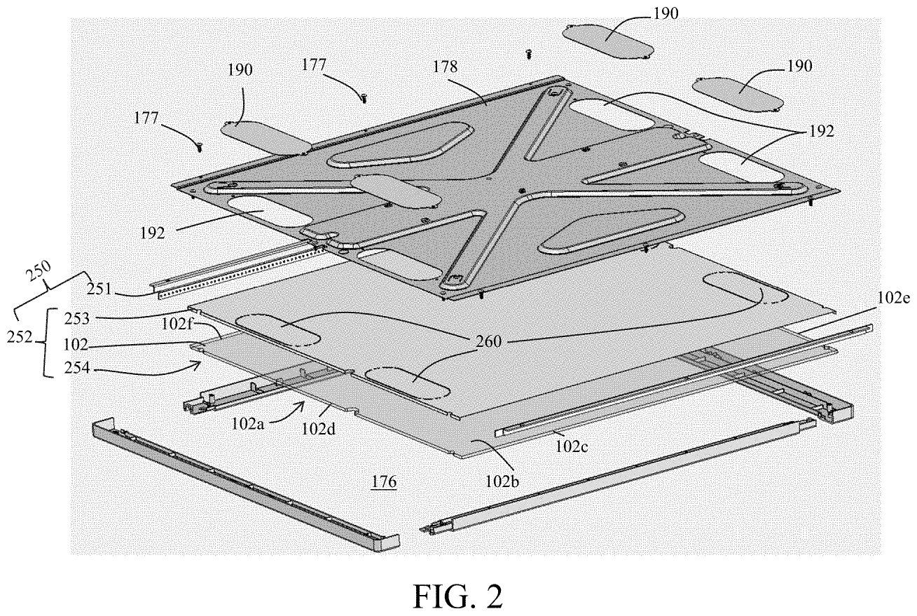

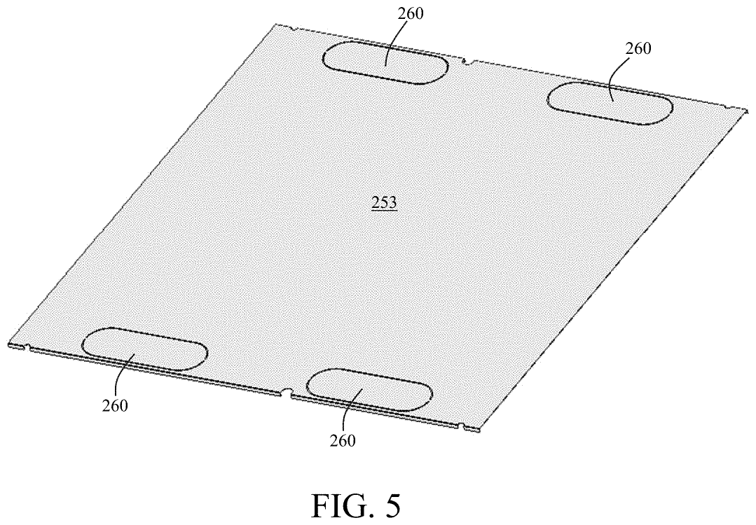

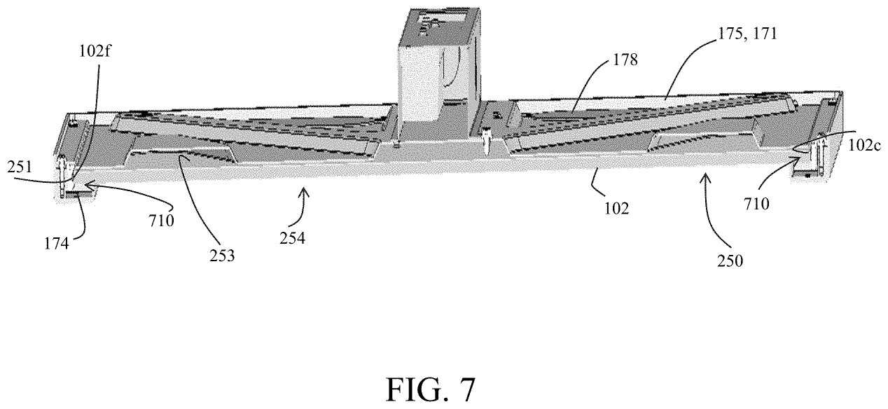

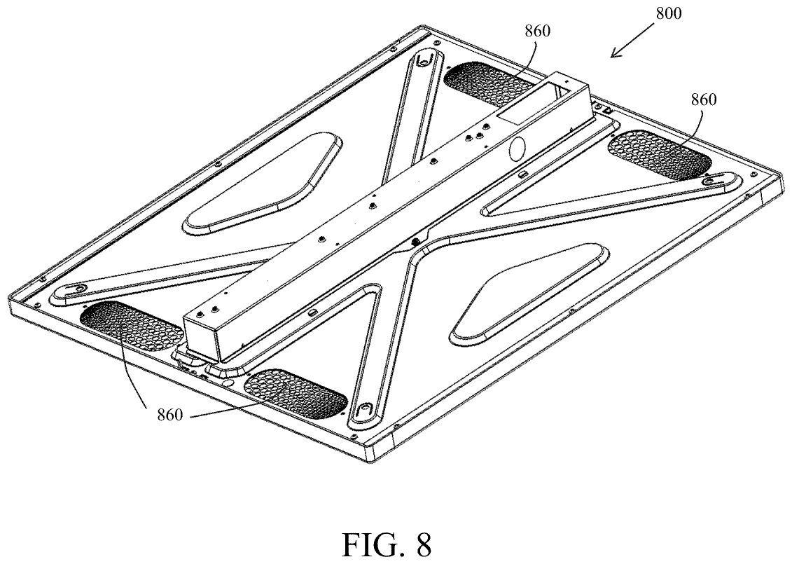

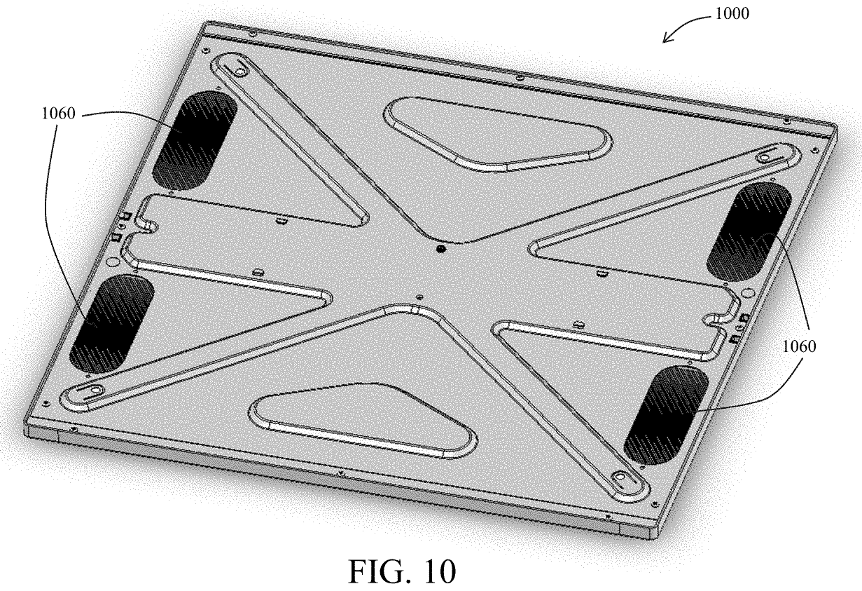

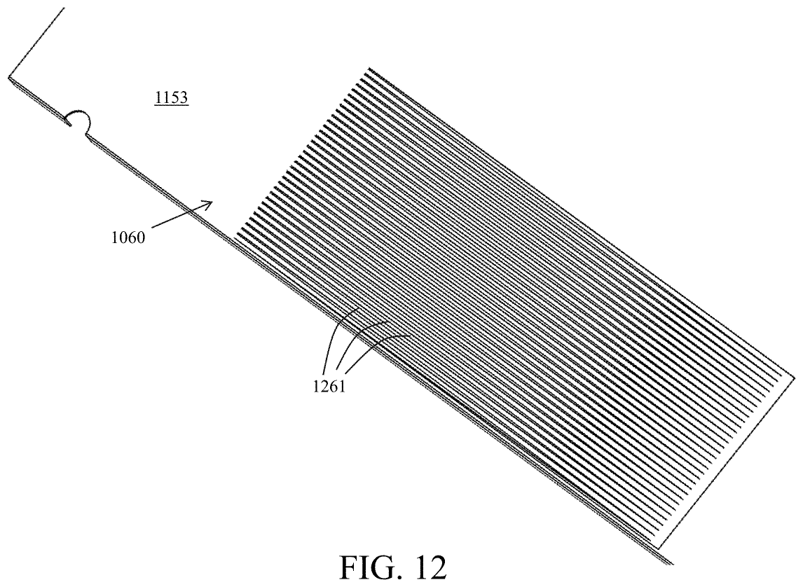

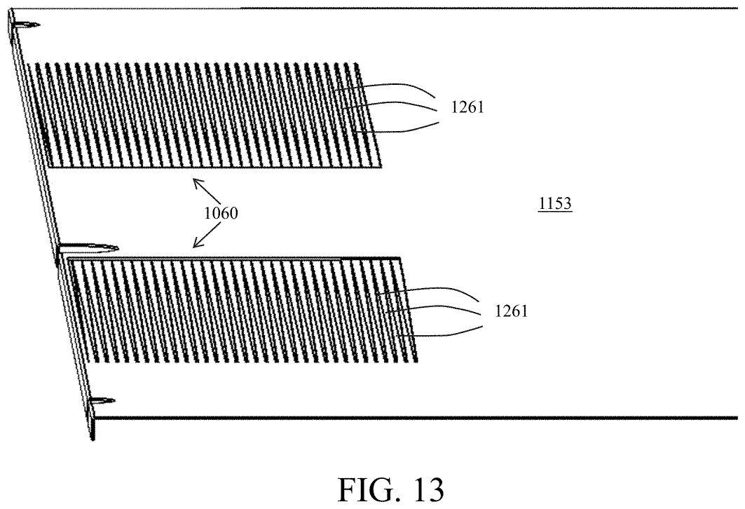

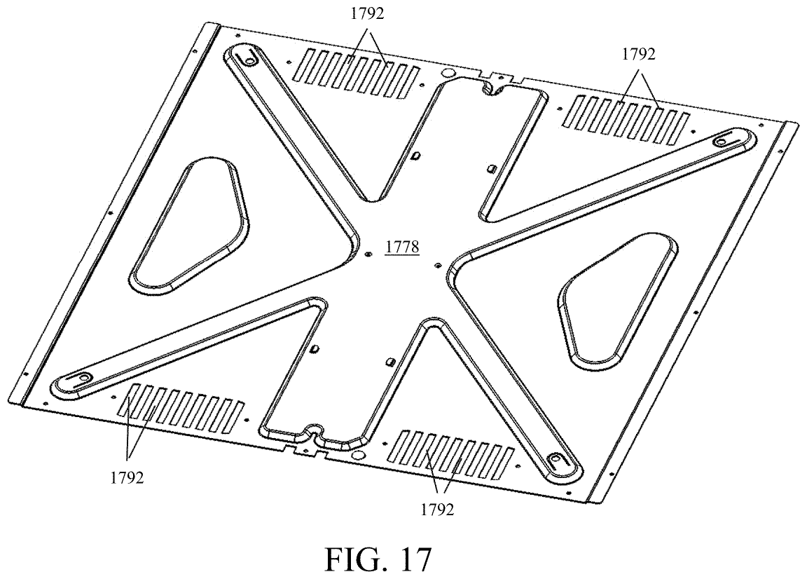

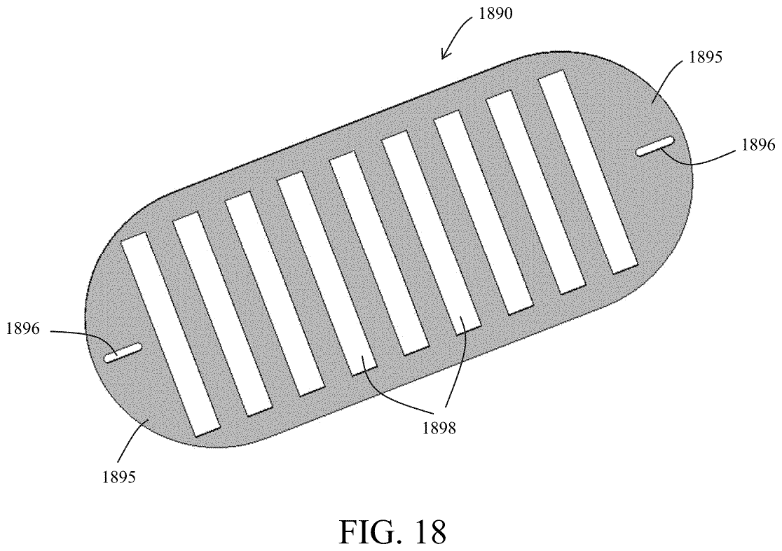

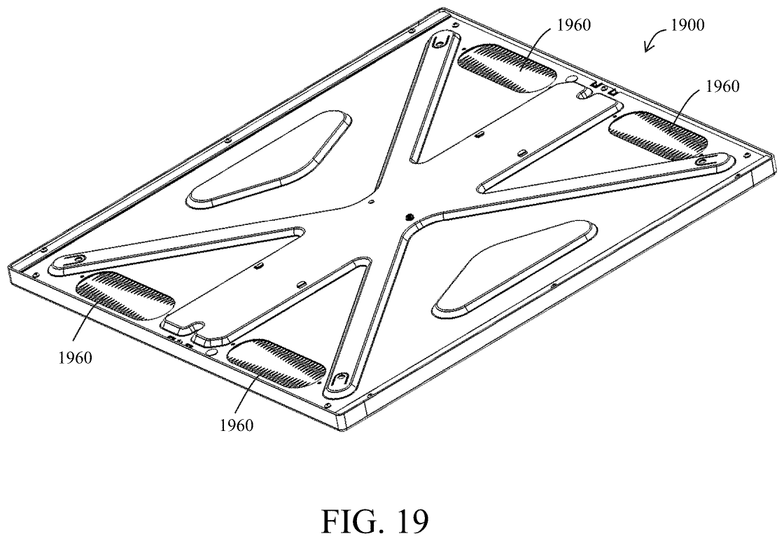

In particular, FIGS. 1-7 will be described in association with a luminaire having an example uplight feature; and FIGS. 8-21 will be described in association with luminaires having other example uplight features. Referring to FIGS. 1-7, an example luminaire 100 of the present disclosure may include a housing assembly 170 that defines an internal cavity 174 (shown in FIG. 7). Further, the luminaire 100 may include a light assembly 250 (shown in FIG. 2) that may be housed within the internal cavity 174 of the housing assembly 170.

The housing assembly 170 may include a front frame 171 that is defined by a plurality of elongate members 175. In one example, the elongate members 175 may be integrally formed to define the front frame 171. However, in other example embodiments, the elongate members 175 may be coupled to each other using fasteners or other attachment mechanisms, such as welding, to define the front frame 171. In either case, the elongate members 175 may be arranged such that they define a light emitting opening 176. For example, the plurality of elongate members 175 may include a pair of side members 172 and a pair of end members 173 that are arranged such that they define the light emitting opening 176 as illustrated in FIG. 1B. In particular, the side members 172 are disposed opposite to and facing each other; and the end members 173 are disposed at opposite ends of the side members 172 as illustrated in FIGS. 1A-2. Each of the elongate members 175, i.e., the side members 172 and the end members 173 may have a substantially L-shaped cross-sectional profile as illustrated in FIG. 7. Further, the elongate members 175 of the front frame 171 may be configured to support the light assembly 250 along the peripheral edges 710 (shown in FIG. 7) of the light assembly 250 such that the light assembly 250 is disposed in the internal cavity 174 defined by the housing assembly 170, and the light assembly 250 covers the light emitting opening 176 defined by the front frame 171.

The light assembly 250 may include a light source 251 and a light transmission unit 252 that is configured to control the light emitted by the light source 251 from the luminaire 100 through the light emitting opening 176 of the luminaire 100. In one example, the light source 251 may include an array or strip of light emitting diodes (LEDs) that are disposed on a substrate as illustrated in FIGS. 2 and 7. However, in other examples, the light source 251 may include any other appropriate artificial light source, such as a florescent tube. The light transmission unit 252 may include a reflector panel 253, a light guide panel 102, and a diffuser panel 254 that are stacked together such that the light guide panel 102 is disposed between the reflector panel 253 and the diffuser panel 254. The light guide panel 102 may be bound by a first major surface 102a, a second major surface 102b that is disposed opposite to the first major surface 102a, and a plurality of side edges (102c-102f) that are substantially perpendicular to the two major surfaces (102a, 102b).

The light source 251 and the light transmission unit 252 of the light assembly 250 may be arranged within the internal cavity 174 of the housing assembly 170 of the luminaire 100 such that: (a) the reflector panel 253 may be disposed between the second major surface 102b of the light guide panel 102 and a back plate 178 of the housing assembly 170 that is coupled to the front frame 171 using fasteners 177, such as screws, rivets, etc., or any other appropriate coupling mechanism to enclose the internal cavity 174 within which the light assembly 250 is disposed, and (b) the light source 251 that is coupled to one or more of the elongate members 175 may be disposed adjacent to and facing a respective side edge (102c, 102d, 102e, or 102f) of the light guide panel 102.

The lightguide panel 102 may be configured to propogate light therethrough by total internal reflection of the light between the first and second major surfaces (102a, 102b). The light entering the lightguide panel 102 through one side edge of the lightguide panel 102 may be propagated towards an opposite side edge. In some example embodiments, a portion of the light may exit the lightguide panel 102 through the side edges (e.g., side edges opposite to the side from which light from the light source enters the lightguide panel 102), while in other example embodiments, reflectance tape may be disposed at the side edges to reflect the light reaching the side edges back into the lightguide panel 102. Light that is emitted into the lightguide panel 102 at relatively shallow angles undergoes total internal reflection and proceeds towards one or more of the side edges, while the light at steeper angles spills through the major surfaces (102a, 102b).

The light guide panel 102 of the light assembly 250 may receive light from a light source 251 through at least one of the side edges (102c-102f) and emit at least a portion of the light through the first major surface 102a and/or the second major surface 102b. Accordingly, the first major surface 102a and the second major surface 102b of the lightguide panel 102 may include surface patterns to allow the light to exit therethrough. The surface patterns may include, but are not limited to, microetches, microlenses, etc. In some examples, the lightguide panel 102 may include micro-prisms disposed therein to emit light through the major surfaces (102a, 102b).

A portion of the light that exits the light guide panel 102 through the first major surface 102a may pass through the diffuser panel 254 and exit to an area to be illuminated through the light emitting opening 176 defined by the front frame 171. In some example embodiments, the diffuser panel 254 may be optional. Further, another portion of the light that exits the light guide panel 102 through the second major surface 102b may be reflected back towards the light guide panel 102 by the reflector panel 253. The portion of the light that is reflected back towards the light guide panel 102 by the reflector panel 253 may pass through the light guide panel 102 and exit via the first major surface 102a of the light guide panel 102 towards the area to be illuminated via the light emitting opening 176.

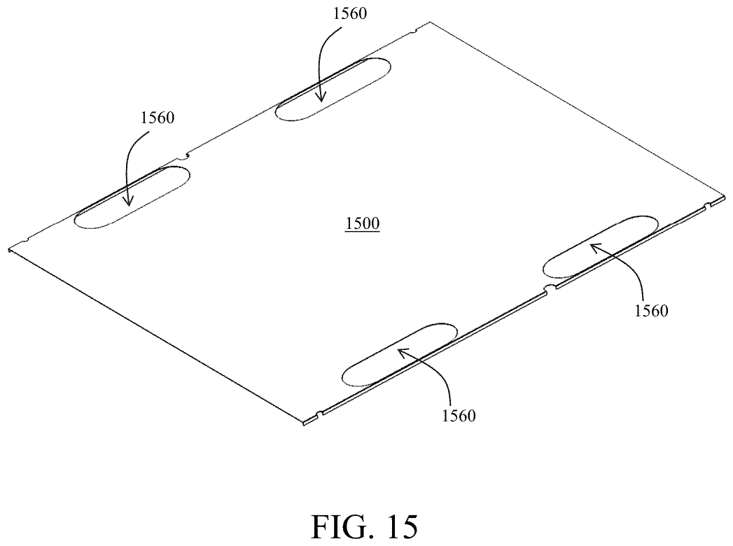

As illustrated in FIGS. 1-7, the luminaire 100 of the present disclosure may include uplight features that are configured to provide selective uplight. The uplight features may include detachable reflector segments 260 of the reflector panel 253. As illustrated in FIGS. 2, 5, and 6, the detachable reflector segments 260 may be marked by perforations on the reflector panel 253 along which the detachable reflector segments 260 can be torn or detached from a remainder of the reflector panel 253 to create reflector openings 1560 (shown in FIG. 15) in the reflector panel 253. The reflector openings 1560 formed in the reflector panel 253 by removing the detachable reflector segments 260 may be configured to allow light that exits the light guide panel 102 through the second major surface 102b to pass therethrough for providing uplight.

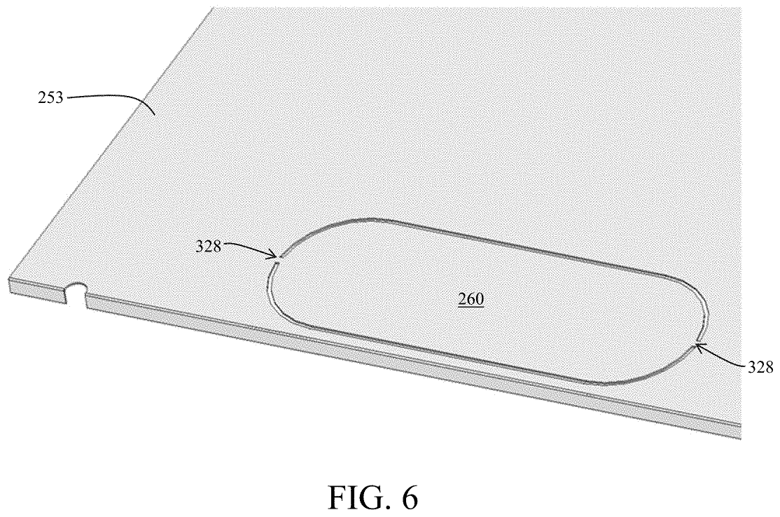

In one example, as illustrated in FIG. 6, the detachable reflector segments 260 may be part of and integrally formed with the reflector panel 253, but configured such that they are detachable or removable from the reflector panel 253 to create the reflector openings 1560 for providing uplight. That is, as illustrated in FIG. 6, the reflector panel 253 may be formed such that a periphery of the detachable reflector segments 260 in the reflector panel 253 may be already detached or pre-cut from the remainder of the reflector panel 253 except for certain sections 328 of the periphery of the detachable panels 260 that may remain connected to the remainder of the reflector panel 253 to keep the detachable panels 260 intact within the reflector panel 253 till they are detached for creating the reflector openings 1560 and providing uplight. In one or more example embodiments, the reflector panel 253 may be thin sheet of plastic or paper that may be reflective or coated with reflective material and having one or more of the detachable reflector segments 260 formed therein.

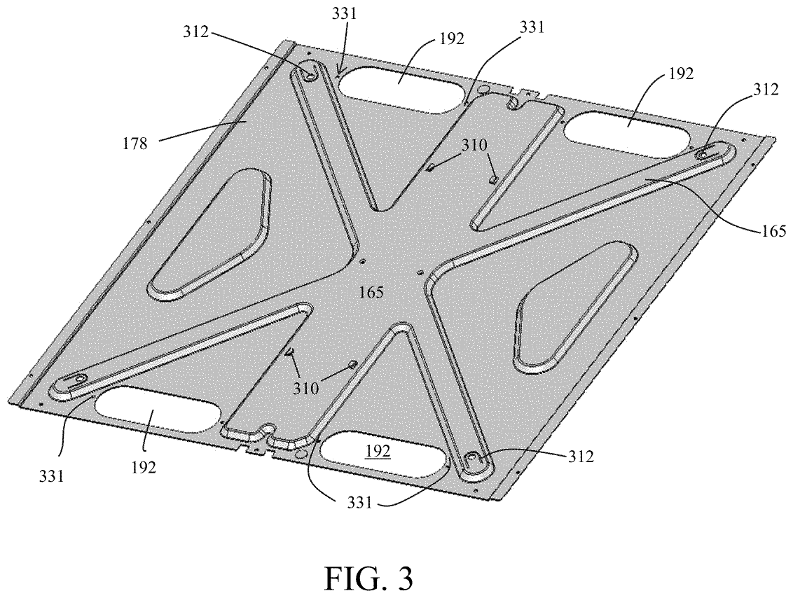

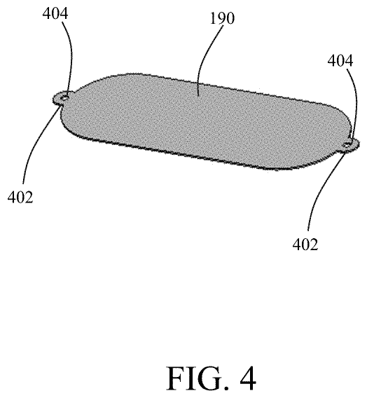

In addition to the detachable reflector segments 260 of the reflector panel 253, as illustrated in FIGS. 1A, and 2-4, the uplight features of the luminaire 100 may include detachable panels 190 that are removably coupled to the back plate 178 of the housing assembly 170 using fasteners 191, such as screws, rivets, etc. The detachable panels 190 may be coupled to the back plate 178 such that they cover the uplight openings 192 that are formed in the back plate 178 through which uplight may exit the luminaire 100. That is, the detachable panels 190 may be configured to cover the uplight openings 192 formed in the back plate 178. Accordingly, to provide uplight, one or more of the detachable panels 190 may be removed to expose the uplight openings 192 and allow the uplight to pass therethrough and exit the luminaire 100. As illustrated in FIGS. 3 and 4, the back plate 178 may include coupling apertures 331 that are disposed adjacent the uplight openings 192 and the detachable panels 190 may include tabs 402 with coupling holes 404 formed therein. The detachable panels 190 may be disposed on the back plate 178 such that the coupling holes 404 formed in the tabs 402 of the detachable panels 190 are axially aligned with respective coupling apertures 331 of the back plate 178; and fasteners 191 may be passed through the axially aligned coupling apertures 331 and the coupling holes 404 to removably couple the detachable panels 190 to the back plate 178. In some example embodiments, the detachable panels 190 may be removably coupled to the back plate 178 using any other appropriate coupling mechanisms without departing from a broader scope of the present disclosure.

In one or more example embodiments, the bottom surface of the detachable panels 190 that face the light transmission unit 252 may be made reflective. For example, the bottom surface of the detachable panels 190 may be painted white, coated with reflective material, etc. The reflective bottom surface of the detachable panels 190 may be configured to allow uplight exiting through the reflector openings 1560 to be reflected back towards the light guide panel 102 and exit the luminaire 100 through the first major surface 102a of the light guide panel 102. For example, after removing the detachable segments 260 from the reflector panel 253 and the detachable panels 190 from the back plate 178 to provide uplight, if a user wants to reduce the amount of uplight or block the uplight, the user can reattach the detachable panels 190 to the back plate 178. In said example, the reflective bottom surface of the detachable panels 190 may reflect light exiting the second major surface 102b of the light guide panel 102 and the reflector openings 1560 formed in the reflector panel 253 to be reflected back to the light guide panel 102 and exit the luminaire 100 through the first major surface 102a of the light guide panel 102.

In particular, the detachable reflector segments 260 of the reflector panel 253 may be positioned within the reflector panel 253 such that they are aligned (e.g., axially or vertically) with the uplight openings 192 of the back plate 178 and the detachable panels 190 covering the uplight openings 192, when the light transmission unit 252 comprising the reflector panel 253 is disposed in the internal cavity 174 defined by the housing assembly 170. To create uplight, a user may remove one of the detachable panels 190 to expose the uplight opening 192 covered by the detachable panel 190. Then, the user may access the detachable reflector segment 260 of the reflector panel 253 that is axially aligned with the uplight opening 192 through the uplight opening 192 of the back plate 178 to tear or remove the detachable reflector segments 260 of the reflector panel 253 to create the reflector opening 1560. Once the detachable panel 190 and the detachable segment 260 are removed, the light exiting the light guide panel 102 through the second major surface 102b may pass through the aligned uplight opening 192 and the reflector opening 1560 and exit the luminaire 100 to provide the uplight.

As illustrated in FIGS. 1-7, the luminaire 100 may include more than one uplight openings 192 formed in the back plate 178, more than one detachable panels 190 coupled to the back plate 178, and more than one detachable reflector segments 260 formed in the reflector panel 253. One or more of the detachable panels 190 and detachable reflector segments 260 may be removed based on the amount of uplight that is desired. For example, after removing one detachable panel 190 and the detachable segment 260 of the reflector panel 253 that is aligned with the detachable panel 190, if more uplight is desired, a user may remove other detachable panels 190 and detachable reflector segments 260 of the reflector panel 253 that are aligned with the detachable panels 190 in a similar manner as described above.

Further, the back plate 178 of the housing assembly 170 may include embossed portions 165 with device mounting features 310 that are configured to mount and support electronic devices, such as drivers 168, emergency battery packs, etc., thereon, as illustrated in FIGS. 1A and 7. That is, one or more electronic devices may be coupled to the embossed portions 165 of the back plate 178 of the luminaire 100. In addition to the device mounting features 310, the back plate 178 may include suspension mounting features 312 formed in the embossed portions to suspend the luminaire 100 from a mounting surface such as a ceiling. The embossed portions 178 may also strengthen and provide stability and rigidity to the back plate 178. However, one of skill in the art can understand and appreciate that in some example embodiments, the back plate 178 may not include the embossed portions 165.

Even though the present disclosure describes the reflector panel 253 as including detachable reflector panels 260 that can be removed or detached from the reflector panel 253 to create the reflector openings 1560 for providing selective uplight, one of skill in the art can understand and appreciate that in other example embodiments, instead of or in addition to the detachable reflector segments, the reflector panel may include patterned segments that define openings in the reflector panel for providing selective uplight. That is, in some example embodiments, one or more of the detachable segments of the reflector panel may be replaced by patterned segments. Each patterned segment in the reflector panel may define a plurality of openings for providing the selective uplight. The plurality of openings defined by each patterned segment may be smaller than a reflector opening 1560 formed by removing a detachable reflector segment 260 from the reflector panel 253. Further, the boundary between the patterned segments and a remainder of the reflector panel 253 may not be as well-defined (e.g., hard lines, cuts, etc.) as with the detachable segments 260. Instead, the boundary between the patterned segments and a remainder of the reflector panel 253 may be frayed or patterned to provide a smoother transition, mixing, and/or blending between the portion of the reflector segment 253 having the patterned segments and a remainder portion of the reflector segment 253. The smooth transition, mixing, and/or blending between the two portions of the reflector (i.e., the portion with patterned segments and the remaining portion) may mitigate the appearance of dark spots in the lightguide panel 102 below the portion of the lightguide panel 102 with the uplight features, i.e., the patterned segments of the reflector panel and the uplight openings 192 in the back plate 178, when a user looks up at the luminaire that is lit (emitting light).

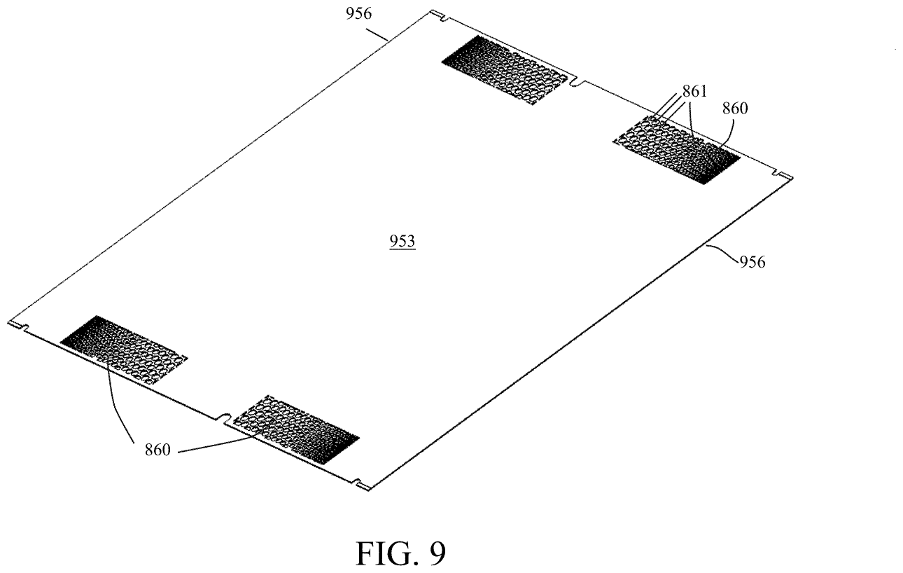

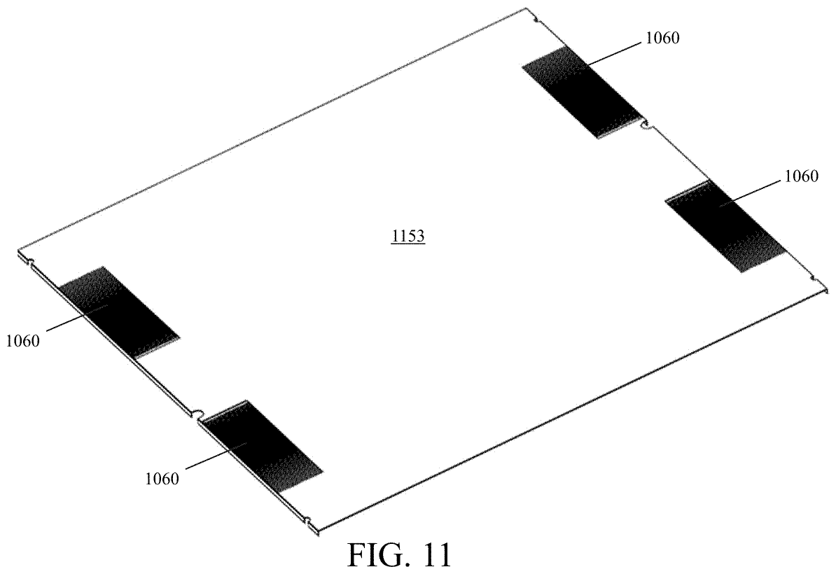

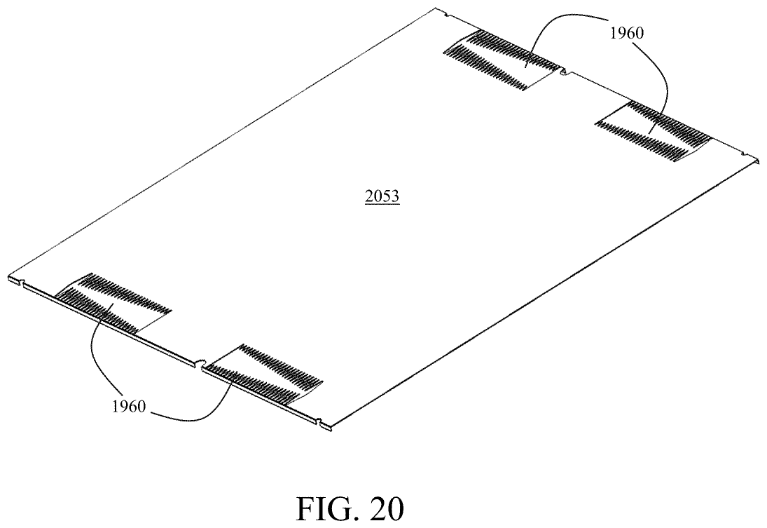

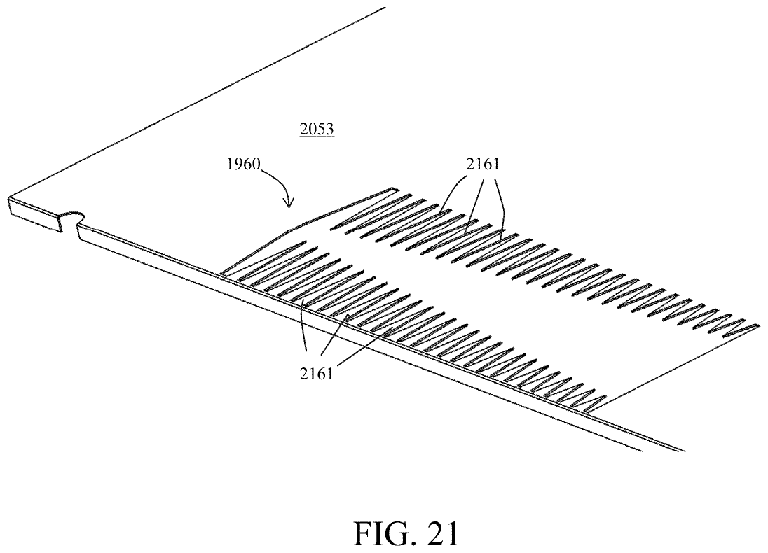

Example embodiments of luminaires having reflector panels with the patterned segments are illustrated in FIGS. 8-13 and 19-21. The luminaires (800, 1000, and 1900) illustrated in FIGS. 8, 10, and 19 are shown with the detachable panels 190 removed from the back plate 178 to expose the patterned segments of the reflector panels associated with each of the luminaires. In one example, as illustrated in FIG. 9, the reflector panel 953 may include patterned segments 860 that define circular openings 861 that graduate or transition in size (diameter) from smaller opening positioned adjacent to the edges 956 of the reflector panel 953 that would be near the light source 251 when positioned in the housing assembly 170 to bigger openings positioned adjacent the center of the reflector panel 253. Alternatively, the larger openings may be positioned adjacent to the edges 956 of the reflector panel 953 that would be near the light source 251 when positioned in the housing assembly 170 and the openings may graduate to smaller openings adjacent the center of the reflector panel 253. In another example, as illustrated in FIGS. 11-13, the reflector panel 1153 may include patterned segments 1060 that define striped or elongate triangular openings 1261. Similarly, in yet another example, as illustrated in FIGS. 20-21, the reflector panel 2053 may include patterned segments 1960 that define striped or elongate triangular openings 2161 that are smaller in size than the striped or elongate triangular openings 1161 of the reflector panel 1053 illustrated in FIGS. 11-13.

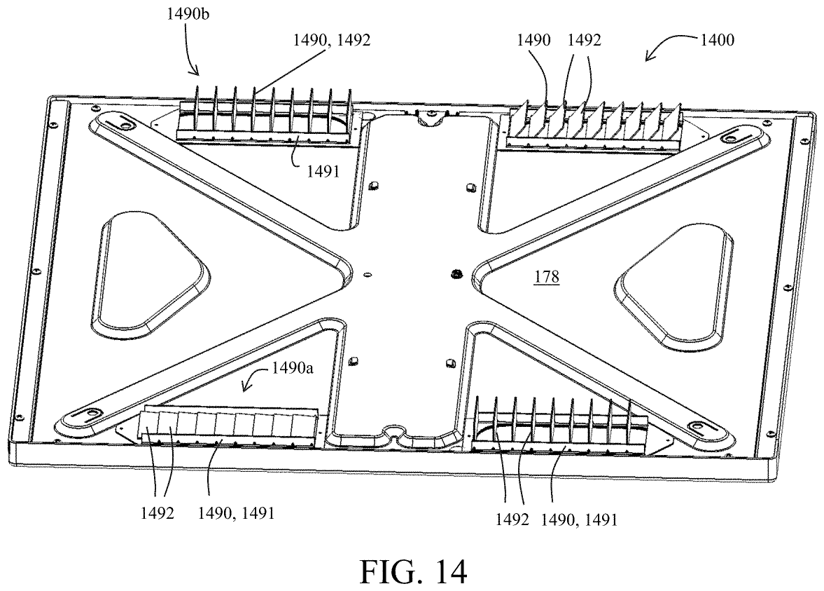

Further, in some example embodiments, the detachable panels 190 that are removably coupled to the back plate 178 may be replaced by louver panels or sliding panels that provide finer control or more granularity in control over the amount of uplight that is emitted from the luminaire 100 than the detachable panels 190. For example, as illustrated in FIGS. 14-15, the luminaire 1400 may include louver panels 1490 that are removably coupled to the back plate 178. Further, the luminaire 1400 may have a reflector panel 1500 with reflector openings 1560 that are pre-cut or formed therein. The reflector panel 1500 may be disposed within the housing assembly 170 such that the reflector openings 1560 of the reflector panel 1500 are aligned (e.g., vertically or axially) with the uplight openings 192 formed in the back plate 178 and the louver panels 1490 that are coupled to the back plate 178 to cover the uplight opening 192. Similar to the detachable panel 190, the bottom surface of the main frame 1491 of the louver panel 1490 and the louvers 1492 coupled to the main frame 1491 of the louver panel 1490 may be made reflective. When the uplight is not desired or in a default state 1495, the louvers 1492 of the louver panel 1490 may be adjusted such that the louver panel 1490 closes the uplight opening 192 of the back plate 178 and the bottom surface of the louver panel 140 reflects light exiting the second major surface 102b of the light guide panel 102 (through the reflector openings 1560) to be reflected back to the light guide panel 102 and exit the luminaire 100 through the first major surface 102a of the light guide panel 102. However, when uplight is desired, the louvers 1492 of the louver panel 1490 may be adjusted to allow light exiting the second major surface 102b of the light guide panel 102 (through the reflector openings 1560) to pass therethrough. The degree to which the louvers 1492 of the louver panel 1490 may be opened from being fully closed 1490a to fully open 1490b may vary (e.g., partially open state 1496, fully open state 1498) based on the amount of uplight that is desired, thereby providing finer control over the amount of uplight emitted from the luminaire 100.

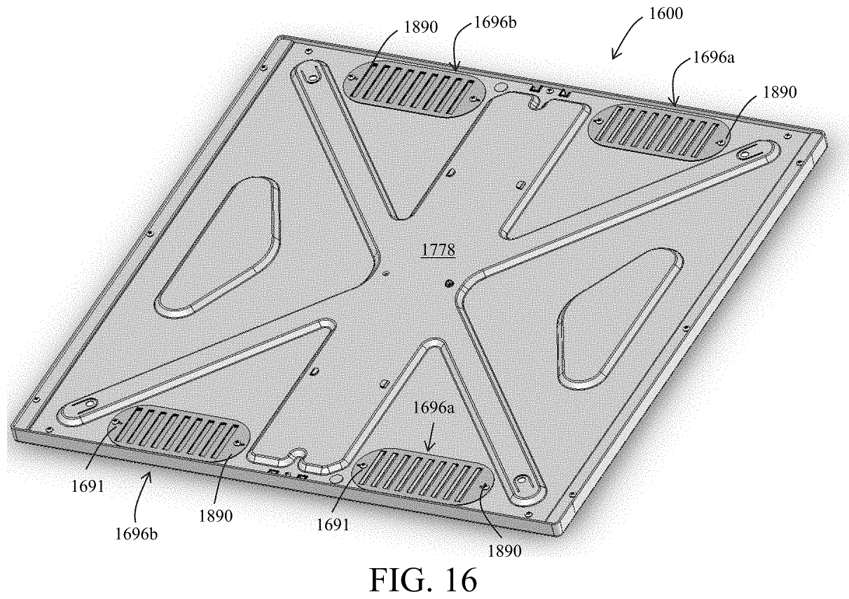

In another example, as illustrated in FIGS. 16-18, the luminaire 1600 may include sliding panels 1890 that are removably coupled to the back plate 1778. Further, the back plate 1778 of the luminaire 1600 may have a plurality of uplight through slots 1792. Furthermore, similar to the luminaire 1400, the reflector panel 1500 of the luminaire 1600 may include reflector openings 1560 that are pre-cut or formed therein. Each sliding panel 1890 may include tabs 1895 that have coupling through slots 1896 formed therein. Further, the sliding panels 1890 may include light passing slots 1898 formed therein. The coupling through slots 1896 may be configured to receive fasteners 1691 therethrough to couple the sliding panel 1890 to the back plate 1778 and adjust the sliding panel 1890 between a first position 1696a where the sliding panel 1890 closes the uplight through slots 1792 formed in the back plate 1778 when no uplight is desired and a second position 1696b where the sliding panel 1890 opens the uplight through slots 1792 in the back plate 1778 to let uplight to pass therethrough and exit the luminaire 1600 when uplight is desired. The degree to which the uplight through slots 1792 in the back plate 1778 are opened by sliding the sliding panel 1890 from the first position 1696a to the second position 1696b may vary based on the amount of uplight that is desired, thereby providing finer control over the amount of uplight emitted from the luminaire 100.

Even though the present disclosure describes the sliding or louver panels being used with reflector panels having pre-cut reflector openings, one of skill in the art can understand and appreciate that the sliding or louver panels may be used with reflector panels having the detachable segments and/or the patterned segments without departing from a broader scope of the present disclosure.

Even though FIGS. 1-21 disclose the detachable panels 190 and the detachable reflector segments or patterned segments (860, 1060, 1960) being positioned adjacent the perimeter of the back plate 178 and the reflector segment (253, 953, 1153, 2053), respectively, one of skill in the art can understand and appreciate that in other example embodiments, the detachable panels 190 and the detachable reflector segments 260 or patterned segments (860, 1060, 1960) may be disposed at any appropriate portion or on any appropriate position of the back plate 178 and the reflector segment (253, 953, 1153, 2053) without departing from a broader scope of the present disclosure. Further, the patterns of the reflector segments that are illustrated in FIGS. 1-21 and described herein are examples and are non-limiting. That is, in other example embodiments, the reflector panels may include any other appropriate pattern that minimizes dark spots and allows uplight to be emitted therethrough.

Although example embodiments are described herein, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A luminaire comprising:
a housing assembly comprising a front frame, a back plate that is coupled to the front frame, and an internal cavity, the back plate comprising an uplight opening formed therein;
a detachable panel that is removably coupled to the back plate such that the detachable panel covers the uplight opening; and
a light transmission unit disposed in the internal cavity of the housing assembly, the light transmission unit comprising:
a lightguide panel that is configured to receive light from a light source through a side edge of the lightguide panel and emit the light through a pair of major surfaces of the lightguide panel that are substantially perpendicular to the side edge, and
a reflector panel comprising a detachable reflector segment formed therein, the reflector panel being disposed on a major surface of the pair of major surfaces of the lightguide panel and between the major surface and the back plate such that the detachable reflector segment is aligned with the uplight opening in the back plate,
wherein the detachable reflector segment and detachable panel comprise uplight features that are configured to be detached from the reflector panel and the back plate, respectively, to provide uplight.

2. The luminaire of claim 1, wherein the detachable reflector segment is marked by perforations.

3. The luminaire of claim 1, wherein the detachable panel comprises a louver panel that is adjustable to control an amount of the uplight emitted from the luminaire.

4. The luminaire of claim 1, wherein the detachable panel comprises a sliding panel that is adjustable to control an amount of the uplight emitted from the luminaire.

5. The luminaire of claim 4:
wherein the sliding panel comprises a coupling slot that is configured to receive a fastener therein to couple the sliding panel to the back plate, and
wherein when the fastener is disposed at one end of the coupling slot, the sliding panel is configured to close the uplight opening, and when the fastener is disposed at an opposite end of the coupling slot, the sliding panel is configured to open the uplight opening.

6. The luminaire of claim 1, wherein the light source includes light emitting diodes (LEDs).

7. The luminaire of claim 1, wherein the luminaire is configured to be suspension mounted.

8. The luminaire of claim 1, wherein the reflector panel comprises a patterned segment formed therein that provides a smooth transition between the detachable reflector segment and a remainder portion of the reflector panel, the patterned segment comprising a plurality of openings that are configured to emit the uplight therethrough.

9. The luminaire of claim 7, wherein the plurality of openings comprise circular holes that transition in size from large holes to small holes from one end to an opposite end of the patterned segment.

10. The luminaire of claim 7, wherein the plurality of openings comprise triangular openings.

11. The luminaire of claim 1, wherein a surface of the detachable panel that faces the uplight opening is coated with reflective material.

12. A luminaire comprising:
a back plate comprising an uplight opening formed therein;
a detachable panel that is removably coupled to the back plate such that the detachable panel covers the uplight opening; and
a light transmission unit comprising:
a lightguide panel that is configured to receive light from a light source through a side edge of the lightguide panel and emit the light through a pair of major surfaces of the lightguide panel that are substantially perpendicular to the side edge, and
a reflector panel that is disposed between one of the pair of major surfaces of the lightguide panel and the back plate, the reflector panel comprising a reflector segment that is aligned with the uplight opening,
wherein the reflector segment and detachable panel comprise uplight features that are configured to provide uplight.

13. The luminaire of claim 12, wherein the reflector segment is formed in the reflector panel such that the reflector segment is detachable therefrom.

14. The luminaire of claim 12, wherein the detachable reflector segment is marked by perforations.

15. The luminaire of claim 12, wherein the reflector panel comprises a patterned segment formed therein that provides a smooth transition between the detachable reflector segment and a remainder portion of the reflector panel, the patterned segment comprising a plurality of openings that are configured to emit the uplight therethrough.

16. The luminaire of claim 15, wherein the plurality of openings comprise circular holes that transition in size from large holes to small holes from one end to an opposite end of the patterned segment.

17. The luminaire of claim 15, wherein the plurality of openings comprise triangular openings.

18. The luminaire of claim 12, wherein the detachable panel comprises a louver panel that is adjustable to control an amount of the uplight emitted from the luminaire.

19. The luminaire of claim 12, wherein the detachable panel comprises a sliding panel that is adjustable to control an amount of the uplight emitted from the luminaire.

20. The luminaire of claim 12, wherein the luminaire is configured to be suspension mounted.
